(19) United States
(12) Patent Application Publication
(10) Pub. No.: US 2025/0299474 A1
(43) Pub. Date: Sep. 25, 2025

(54) ELECTRONIC DEVICE, NON-TRANSITORY COMPUTER READABLE STORAGE MEDIUM, AND METHOD FOR COLLECTING TRAINING DATA

(71) Applicant: THINKWARE CORPORATION, Seongnam-si (KR)

(72) Inventors: Haejun JUNG, Seongnam-si (KR); Dongwon SHIN, Seongnam-si (KR)

(21) Appl. No.: 19/084,801

(22) Filed: Mar. 20, 2025

(30) Foreign Application Priority Data
Mar. 20, 2024 (KR) 10-2024-0038524

(51) Int. Cl. G06V 10/774; G06V 10/82; G06V 20/56

(52) U.S. Cl. CPC G06V 10/774; G06V 10/82; G06V 20/56

(57) ABSTRACT

An electronic device in a vehicle may comprise communication circuitry, a camera, a memory storing instructions, and a processor. The instructions may, when executed by the processor, cause the electronic device to execute a first model to detect one or more subjects from a first image obtained from the camera and obtain, by executing a second model using feature information obtained from the first model, a second image based on the feature information.

### CROSS-REFERENCE TO RELATED APPLICATIONS

This application is based on and claims priority under 35 U.S.C. § 119 to Korean Patent Application No. 10-2024-0038524, filed on Mar. 20, 2024, in the Korean Intellectual Property Office, the disclosure of which is incorporated by reference herein in its entirety.

### BACKGROUND

### Field

The disclosure relates to an electronic device, a non-transitory computer-readable storage medium, and a method for gathering training data.

### Description of Related Art

Neural networks, such as deep neural networks (DNNs), may be used to provide autonomous driving services for vehicles. The performance of such neural networks may be limited by the quantity and quality of data used to train the neural network.

The above-described information may be provided as related art for the purpose of helping understanding of the disclosure. No claim or determination is made as to whether any of the foregoing is applicable as background art in relation to the disclosure.

### SUMMARY

In an embodiment, an electronic device in a vehicle may comprise communication circuitry, a camera, a memory storing instructions, and a processor. The instructions may, when executed by the processor, cause the electronic device to execute a first model to detect one or more subjects from a first image obtained from the camera and obtain, by executing a second model using feature information obtained from the first model, a second image based on the feature information.

According to an embodiment, a non-transitory computer-readable storage medium may store one or more programs. The one or more programs may, when executed by a processor of an electronic device including communication circuitry and a camera, cause the electronic device to execute a first model to detect one or more subjects from a first image obtained from the camera and obtain, by executing a second model using feature information obtained from the first model, a second image based on the feature information.

In an embodiment, a method of an electronic device of including communication circuitry and a camera may comprise executing a first model to detect one or more subjects from a first image obtained from the camera and obtaining, by executing a second model using feature information obtained from the first model, a second image based on the feature information.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B illustrate an example of a conventional truck;

FIG. 1C is an exemplary block diagram illustrating an electronic device in a vehicle according to an embodiment;

FIG. 2 is an exemplary block diagram illustrating a method for gathering training data for an autonomous driving system of a vehicle;

FIG. 3 is a flowchart illustrating operations of an electronic device according to an embodiment;

FIG. 4 is a block diagram illustrating an example of an autonomous driving system of a vehicle according to an embodiment.

FIGS. 5 and 6 are block diagrams illustrating an example of an autonomous driving moving object according to an embodiment;

FIG. 7 illustrates an example of a gateway related to a user device according to various embodiments;

FIG. 8 is a view illustrating operations of an electronic device training a neural network based on a set of training data according to an embodiment; and

FIG. 9 is a block diagram illustrating an electronic device according to an embodiment.

### DETAILED DESCRIPTION

Specific structural or functional descriptions of embodiments according to the concept of the disclosure disclosed herein are merely exemplified for the purpose of describing embodiments according to the concept of the disclosure, and embodiments according to the concept of the disclosure may be implemented in various forms and are not limited to the embodiments described in the disclosure.

Since various changes or modifications may be made to embodiments according to the concept of the disclosure, specific embodiments are be illustrated in the drawings and described herein. However, without limitations to the embodiments according to the concept of the disclosure, all changes and/or equivalents or replacements thereto also belong to the scope of the disclosure.

The terms “first” and “second” may be used to describe various components, but the components should not be limited by the terms. The terms are solely for the purpose of distinguishing one component from another. For example, a first component may be referred to as a second component, without departing from the scope of the claims according to the concept of the disclosure. Similarly, a second component may also be referred to as a first component.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when a component is “directly connected to” or “directly coupled to” another component, no other intervening components may intervene therebetween. Other terms or phrases representing the relationship between components, such as ‘between,’ ‘immediately between,’ or ‘directly adjacent to,’ may be interpreted the same way.

The terms as used herein are provided merely to describe some embodiments thereof, but not to limit the disclosure. As used herein, the singular forms “a,” “an,” and “the” are intended to include the plural forms as well, unless the context clearly indicates otherwise. It will be further understood that the terms “comprise” and/or “have,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the embodiments are described in detail with reference to the accompanying drawings. However, the disclosure is not limited to the exemplary embodiments. The same reference numerals presented in the drawings may denote the same components, and no duplicate description is given.

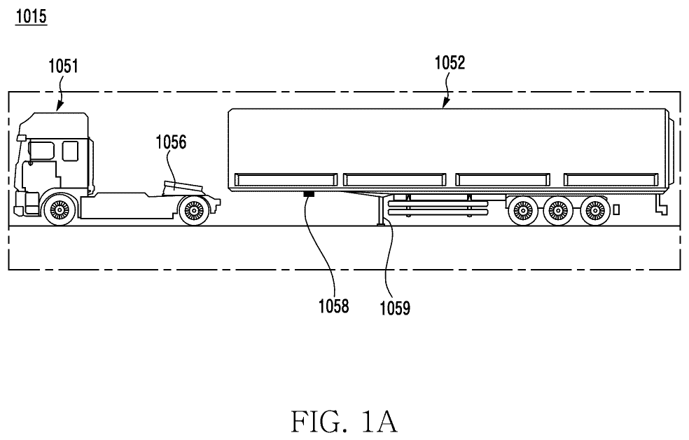

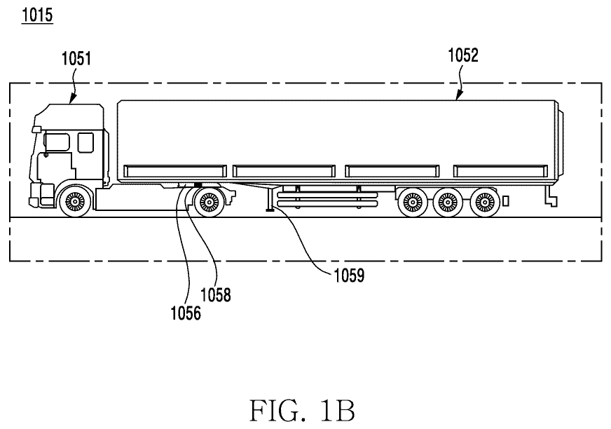

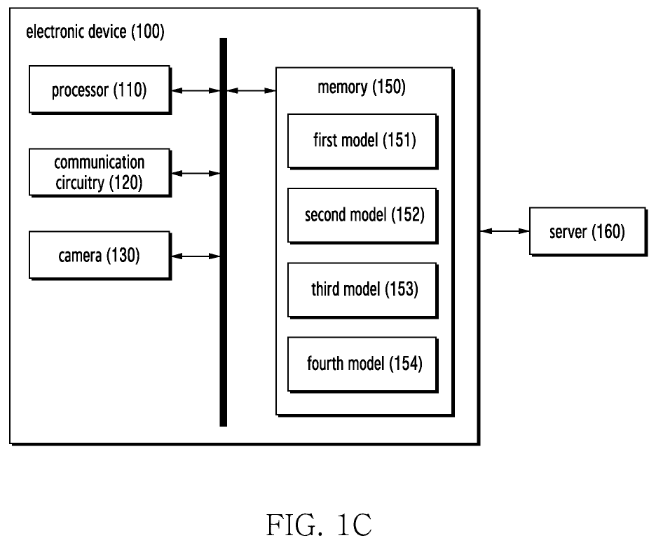

FIGS. 1A and 1B illustrate an example of a conventional truck. Throughout the years, the trucking industry experienced steady growth and expanded the reach of its services to respond to more complex supply chains. These services include last-mile deliveries, drop-trailer programs, and intermodal transportation at ports (in which freight is carried to the destination by two or more different means of transportation (ship and rail, ship and airplane).

As such, because the methods of transporting freight are very diverse, manufacturers of freight-related equipment have designed different types of equipment to transport freight according to various transportation needs.

In the disclosure, a truck that tows a trailer for the main purpose of freight carrying or catering is collectively referred to as a tractor.

Tractors described in the disclosure may be classified into conventional trucks (or bonneted trucks), cab-over trucks (or cab-over engines), and semi-conventional trucks, which are intermediate forms of conventional trucks and cab-over trucks, depending on the location and shape of the tractor's cab.

The conventional truck has a structure in which the engine and the hood are positioned on the front axle of the tractor's cap, allowing the driver to sit behind the front axle, and is a type of tractor mainly used in North America where the tractor's engine is positioned in front of the driver.

On the other hand, the cap-over truck has a structure in which the cap of the tractor is positioned to the front end of the tractor, allowing the driver to sit in front of the front axle, and the front of the tractor is in the form of a so-called “flat face (or flat nose)” where the tractor's engine is positioned below the driver, which is a type of tractor mainly used in most countries such as Europe and Asia.

Just as there are various forms depending on the purpose and demand of a tractor, there are various forms of trailers towed by tractors. Among them, the most representative types of trailers are full-trailers and semi-trailers. The full-trailer and the semi-trailer may be distinguished by whether the trailer is equipped with both front and rear axles. Such a trailer may be connected to a box truck or a tractor through a coupling device.

Specifically, the full-trailer is a commercial freight trailer equipped with both front and rear axles. The full-trailer is designed to support the total load only with the trailer, so that it may fully support its weight without relying on a tractor, and is equipped with a drawbar to be coupled with a hauling unit (or towing unit) such as a tractor, and is mainly in the United States and Canada.

On the other hand, the semi-trailer is a freight trailer equipped with only a rear axle without a front axle, and supports a large portion of the load by a tractor connected by a type of hitch called a “fifth wheel.” When the semi-trailer is detected from the tractor and becomes stationary, the load of the trailer may be supported by spreading the landing gear mounted on the lower portion of the semi-trailer perpendicularly to the ground. A combination of a semi-trailer and a tractor is referred to as a “semi-trailer truck” (in the U.S., simply referred to as a “semi-trailer,”, a “tractor-trailer,” a “semi-truck,” a “big rig,” or a “semi”). The above-described “fifth wheel” refers to a horizontal wheel attached to the tractor axle of the trailer truck to facilitate the direction change of the trailer. The “fifth wheel” is a device that allows the tractor and the semi-trailer to be operably coupled to each other and typically includes a lower portion constituted of a hitch device and a trunnion plate for securing the kingpin mounted on the semi-trailer to the tractor.

Hereinafter, in the disclosure, based on the terms of the tractors/trailers described above, “trailer” is used as referring to a freight transportation vehicle connected to a tractor for a trailer, and “trailer” is used as referring to a towing vehicle for moving the trailer for convenience of description. Further, in the disclosure, in order to exclude the limitation of rights according to the embodiments described in the detailed description as much as possible, a tractor that hauls/tows a “trailer” may be described interchangeably with “towing vehicle” and a trailer towed by a tractor may be described interchangeably with “towed vehicle.”

Further, for convenience of description, it is preferable to understand that the “trailer” described throughout the specification refers to a “semi-trailer,” but is not limited thereto.

Referring to FIGS. 1A and 1B, the vehicle 1015 may include a tractor or tractor unit 1051 and a semi-trailer 1052. FIG. 1A illustrates a state in which the tractor 1051 and the semi-trailer 1052 are not connected, and FIG. 1B illustrates a state in which the tractor 1051 and the semi-trailer 1052 are connected.

In an embodiment, the semi-trailer 1052 may be selectively connected by a fifth wheel hitch 1056 carried by the tractor 1051, and the fifth wheel hitch 1056 may engage to the kingpin 1058 fixed to the semi-trailer 1052 in a known manner. The vehicle 1015 including the tractor 1051 and the semi-trailer 1052 may be referred to as a truck. The vehicle 1015 may include only the tractor 1051. The semi-trailer 1052 shown in FIGS. 1A and 1B is illustrated as a “semi-trailer” form, but this is for convenience of description, and it should not be understood that the embodiments of the disclosure are applied only to a “semi-trailer” form. The tractor 1051 shown in FIGS. 1A and 1B is illustrated as a “cab-over truck” form, but this is for convenience of description, and it should not be understood that the embodiments of the disclosure are applied only to a “cab-over truck” form.

In an embodiment, the semi-trailer 1052 may include a king pin 1058 coupled to the fifth wheel hitch 1056 of the tractor 1051 and a landing gear 1059 that supports the semi-trailer 1052 against the ground when the semi-trailer 1052 is not coupled to the tractor 1051. The king pin 1058 and the landing gear 1059 may be installed (or disposed) on the lower portion of the semi-trailer 1052.

In an embodiment, to support driving on curved roads, the semi-trailer 1052 may be rotatably coupled to the tractor 151. For example, the tractor 1051 and the semi-trailer 1052 may be rotatably coupled through a coupling device including the fifth wheel hitch 1056 and the king pin 1058. However, the link mechanism between the tractor 1051 and the semi-trailer 1052 is not limited thereto.

FIG. 1C is an exemplary block diagram illustrating an electronic device in a vehicle according to an embodiment. Referring to FIG. 1C, according to an embodiment, the electronic device 100 may include a processor 110, a memory 150, a communication circuitry 120, and a camera 130. In an embodiment, the processor 110, the memory 150, the communication circuitry 120, and/or a camera 130 may be electrically and/or operatively connected to each other by an electronic component such as a communication bus. Hereinafter, “pieces of hardware are operatively coupled” may mean that a direct or indirect connection between the pieces of hardware is established wiredly or wirelessly so that a second piece of hardware is controlled by a first piece of hardware among the pieces of hardware.

Although FIG. 1C illustrates that the processor 110, the memory 150, the camera 130, and the communication circuitry 120 in different blocks, the disclosure is not limited thereto. Some of the pieces of hardware of FIG. 1C may be implemented as a single integrated circuit such as a system on chip (SoC) or a single package.

The memory 150 according to an embodiment may store instructions. The processor 110 may be configured to process data based on the instructions stored in the memory 150. For example, the processor 110 may include an arithmetic and logic unit (ALU), a floating point unit (FPU), a field programmable gate array (FPGA), a central processing unit (CPU), and/or an application processor (AP). The processor 110 may have a structure of a single-core processor 110 or a structure of a multi-core processor such as a dual core, a quad core, a hexa core, or an octa core.

According to an embodiment, the memory 150 may include a hardware component for storing data and/or instructions executable by the processor 110. The memory 150 may include, e.g., volatile memory such as random-access memory (RAM), and/or non-volatile memory such as read-only memory (ROM). For example, the volatile memory may include, e.g., at least one of dynamic RAM (DRAM), static RAM (SRAM), cache RAM, and pseudo SRAM (PSRAM). For example, the non-volatile memory may include at least one of, e.g., programmable ROM (PROM), erasable PROM (EPROM), electrically erasable PROM (EEPROM), flash memory, hard disk, compact disk, solid state drive (SSD), and embedded multi-media card (eMMC).

In an embodiment, the memory 150 of the electronic device 100 may include a neural network model. For example, the electronic device 100 may include a first model 151, a second model 152, a third model 153, and a fourth model 154 stored in the memory 150.

In an embodiment, the first model 151 may include a neural network model (e.g., an object detection model) for detection and segmentation of an object in an image. For example, the first model 151 may include a neural network such as a convolutional neural network (CNN). For example, the first model 151 may include an input layer, an intermediate layer (or a hidden layer), and an output layer. The intermediate layer of the first model 151 may include a convolutional layer for extracting features from input data (e.g., an image input to the first model 151 or a feature map that is an output of the convolutional layer) by applying a kernel (or a filter).

In an embodiment, the fourth model 154 may include a model for determining whether to use the analysis result (or detection result) of the image obtained by the first model 151. For example, the electronic device 100 may determine whether to transmit the detection result of the image obtained by the first model 151 to the server 160 by executing the fourth model 154. For example, by executing the fourth model 154, the electronic device 100 may determine whether to execute the second model 152 based on the detection result of the image obtained by the first model 151. For example, the electronic device 100 may transmit the detection result of the image to the server 160 or execute the second model 152 based on the detection result of the image when the detection result of the image meets a predetermined setting or/or the reliability of the detection result of the image is larger than or equal to a threshold value using the fourth model 154. For example, using the fourth model 154, the electronic device 100 may compare the training data used for the training of the first model 151 with information (e.g., analysis results) about the image input to the first model 151 and determine whether to expand the training data for the training of the first model 151 using the image.

In an embodiment, the second model 152 and the third model 153 may constitute a generative adversarial network (GAN) (e.g., deep convolutional GAN (DCGAN)). For example, the second model 152 may include a generator of a GAN, and the third model 153 may include a discriminator of a GAN. The second model 152 may be used to generate artificial data based on input data. The third model 153 may be used to distinguish whether the artificial data generated by the second model 152 is actual data based on similarity or probability. The second model 152 and the third model 153 may be configured to learn adversarially. Optionally, the third model 153 may not be used to generate and gather data for machine learning of an autonomous driving system. When the third model 153 is used to generate and gather data for this purpose, it may be determined whether the data generated by the second model 152 is data that needs to be gathered for machine learning of the autonomous driving system. The second model 152 and/or the third model 153 may include at least one of a GAN-based model such as CycleGAN or StyleGAN, a convolutional neural network, a residual network (ResNet), a transformer, and/or a U-Net, but is not limited thereto.

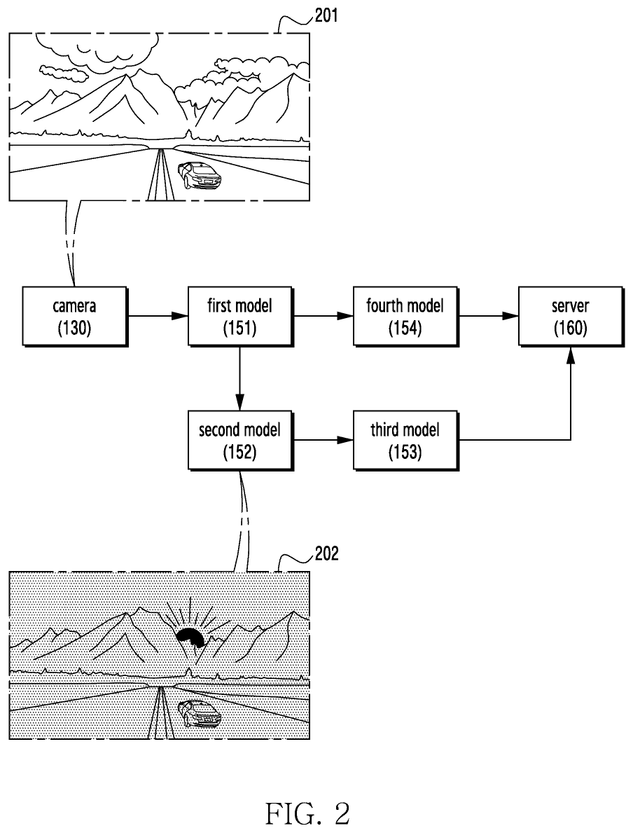

In an embodiment, the operations of the electronic device 100 caused by executing the first model 151, the second model 152, the third model 153, and the fourth model 154 by the processor 110 are described below with reference to FIG. 2.

According to an embodiment, the communication circuitry 120 may be utilized for wired and/or wireless communication with an external electronic device. For example, the electronic device 100 may be configured to wiredly and/or wirelessly communicate with the server 160 using the communication circuitry 120. The communication circuitry 120 may include at least one of, e.g., a modem, an antenna, and an optic/electronic (O/E) converter. The communication circuitry 120 may support transmission and/or reception of electric signals based on various types of protocols such as Ethernet, local area network (LAN), wide area network (WAN), wireless fidelity (Wi-Fi), near-field communication (NFC), Bluetooth, Bluetooth low energy (BLE), ZigBee, long term evolution (LTE), fifth generation (5G) new radio (NR), sixth generation (6G), and/or above-6G.

According to an embodiment, the camera 130 may include a lens assembly or an image sensor. The lens assembly may collect light emitted or reflected from an object whose image is to be taken. The lens assembly may include one or more lenses. For example, the camera 130 may include a plurality of lens assemblies. For example, some of the plurality of lens assemblies of the camera 130 may have the same lens attribute (e.g., field of view, focal length, auto-focusing, f number, or optical zoom), or at least one lens assembly may have one or more lens attributes different from those of another lens assembly. The lens assembly may include a wide-angle lens or a telephoto lens. For example, the electronic device 100 may include a flash for the camera 130. The flash may include one or more light emitting diodes (LEDs) (e.g., a red-green-blue (RGB) LED, a white LED, an infrared (IR) LED, or an ultraviolet (UV) LED) or a xenon lamp. For example, the image sensor may obtain an image corresponding to an object by converting light emitted or reflected from the object and transmitted via the lens assembly into an electrical signal. According to an embodiment, the image sensor may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor may be implemented using, e.g., a charged coupled device (CCD) sensor or a complementary metal oxide semiconductor (CMOS) sensor.

According to an embodiment, the electronic device 100 may obtain an image of a surrounding environment (e.g., the first image 201 of FIG. 2) using the camera 130. For example, the electronic device 100 may obtain an image of a surrounding environment of a vehicle driving on a road.

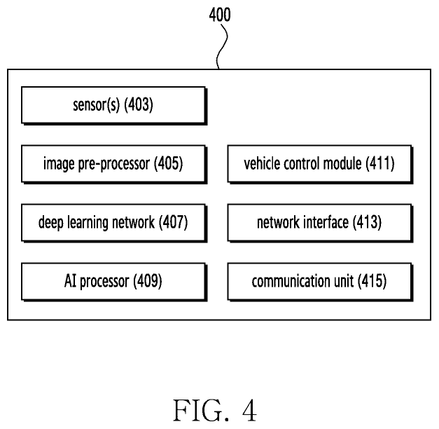

In an embodiment, the electronic device 100 may obtain or gather data for machine learning of an autonomous driving system (e.g., the autonomous driving system 400 of FIG. 4), and transmit the obtained or gathered data to the server 160. The server 160 may manage data used for training the autonomous driving system. As machine learning models to support autonomous driving of vehicles, such as deep neural networks (DNNs), become increasingly complex, larger amounts and higher quality training data or datasets are required. When only the image obtained from the camera 130 of the vehicle is used as the training data, the amount of training data may be limited, and accordingly, the performance of autonomous driving may also be limited. According to an embodiment, the electronic device 100 may build an enhanced performance neural network by gathering images generated based on images obtained from the camera 130 as training data.

FIG. 2 is an exemplary block diagram illustrating a method for gathering training data for an autonomous driving system of a vehicle. The operations described with reference to FIG. 2 may be performed by the electronic device 100 of FIG. 1C or the processor 110 of the electronic device 100.

Referring to FIG. 2, the electronic device 100 may obtain a first image 201 using the camera 130. The first image 201 may be an image of an environment in which the vehicle including the electronic device 100 is driving. The first image 201 may include one or more subjects (or objects), such as the road on which the vehicle is driving, and another vehicle around the vehicle.

In an embodiment, the electronic device 100 may transmit the first image 201 from the camera 130 to the first model 151. The electronic device 100 may execute the first model 151 to detect one or more subjects included in the first image 201. The electronic device 100 may obtain a result of detecting subjects included in the first image 201 using the first model 151. For example, the electronic device 100 may obtain a detection result of one or more subjects included in the first image 201 from the first model 151 to which the first image 201 is input. The detection result may include, e.g., information about a bounding box designated by coordinates on the first image 201, a category (or class) of a subject related to the bounding box, and a probability of matching the subject and the category corresponding to the bounding box, but is not limited thereto.

In an embodiment, the electronic device 100 may transmit the detection result of the first image 201 obtained using the first image 201 and the first model 151 to the fourth model 154. The electronic device 100 may execute the fourth model 154 to determine whether to gather the detection results of the first image 201 and the first image 201. The electronic device 100 may selectively transmit information related to the detection result of the first image 201 and one or more subjects in the first image 201 to the server 160 according to the determination result using the fourth model 154.

In an embodiment, the electronic device 100 may obtain feature information (or intrinsic information) related to the first image 201 from the first model 151 into which the first image 201 is input. For example, when it is determined that the gathering of the detection results of the first image 201 and the first image 201 is necessary (or when it is transmitted to the server 160), the feature information related to the first image 201 may be obtained. The electronic device 100 may transmit the feature information from the first model 151 to the second model 152. The feature information may be an output of the intermediate layer of the first model 151. For example, the feature information may be an output of the convolutional layer of the first model 151.

In an embodiment, the electronic device 100 may execute the second model 152 using feature information obtained from the first model 151. The electronic device 100 may obtain the second image 202 based on the feature information by executing the second model 152 using the feature information obtained from the first model 151. For example, the second model 152 may generate the second image 202 using the feature information related to the first image 201. The second image 202 may be an image in which at least some of the features of the first image 201, such as weather (e.g., sunny, cloudy, rain, or snow), time range (e.g., dawn, day, or night), color of the subject, and pattern of the subject, have been changed into new features. Additionally, or optionally, to obtain the second image 202, the first image 201 may be used together with the feature information.

In an embodiment, the electronic device 100 may transmit the second image 202 from the second model 152 to the third model 153. The electronic device 100 may execute the third model 153 using the second image 202. The electronic device 100 may determine whether gathering of the second image 202 is necessary by executing the third model 153 using the second image 202. For example, the electronic device 100 may determine whether to transmit the second image 202 to the server 160 using the third model 153 executed based on the second image 202. For example, the electronic device 100 may determine whether to transmit the second image 202 to the server 160 by identifying whether a parameter related to the second image 202 exceeds a preset threshold. For example, the electronic device 100 may transmit the second image 202 to the server 160 through the communication circuitry 120 if the parameter related to the second image 202 exceeds the threshold, or otherwise may not transmit the second image 202 to the server 160. Accordingly, data necessary for training the DNN for autonomous driving may be selectively gathered.

In an embodiment, the electronic device 100 may generate a plurality of images using the feature information corresponding to the second image 202 determined to be gathered, and may transmit the generated images to the server 160. Accordingly, a plurality of training data having high quality may be gathered.

In an embodiment, runtime discriminator reinforcement learning may be used as a logic for gathering a large amount of training data corresponding to a situation frequently encountered by a vehicle. For example, if the second image 202 is not gathered, the third model 153 may be trained using the identification result stored in the buffer of the memory 150 while the vehicle is driving. For example, when the first model 151 identifies one truck in an image, a label indicating the identified result may be generated. The generated label may be used for training the third model 153.

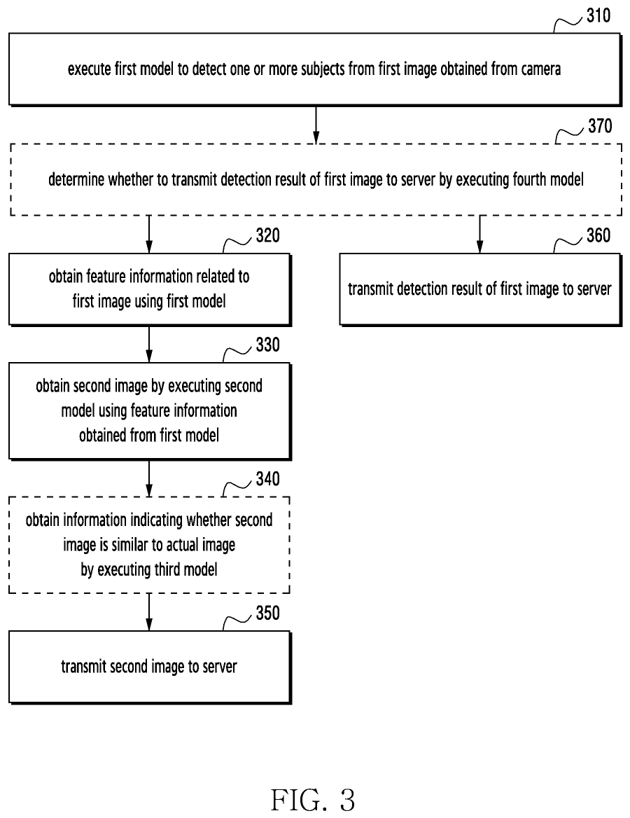

FIG. 3 is a flowchart illustrating operations of an electronic device according to an embodiment. The operations of FIG. 3 may be performed by the electronic device 100 of FIG. 1C or the processor 110 of the electronic device 100. Each of the operations of FIG. 3 may be sequentially performed, but is not necessarily performed sequentially. For example, the order of each operation may be changed, and at least two operations may be performed in parallel.

Referring to FIG. 3, in operation 310, the electronic device 100 may execute the first model 151 to detect one or more subjects from the first image 201 obtained from the camera 130. The electronic device 100 may obtain information about a detection result of one or more subjects in the first image 201, which is an output of an output layer (e.g., a fully-connected layer) of the first model 151.

In operation 320, the electronic device 100 may obtain feature information related to the first image 201 using the first model 151. For example, the electronic device 100 may obtain the feature information related to the first image 201, which is an output of an intermediate layer of the first model 151.

In operation 330, the electronic device 100 may obtain the second image 202 by executing the second model 152 using the feature information obtained from the first model 151. As described above, the second image 202 may be an image newly generated based on the first image 201. For example, the second image 202 may include features different from at least some of the features of the first image 201.

In operation 340, the electronic device 100 may obtain information indicating whether the second image 202 is similar to the actual image by executing the third model 153. For example, the electronic device 100 may obtain information indicating the similarity between the second image 202 generated by the second model 152 and the actual image (e.g., the first image 201) or the probability that the second image 202 is the actual image. However, operation 340 may be omitted. In this case, the electronic device 100 may perform operation 350 after performing operation 330.

In operation 350, the electronic device 100 may transmit the second image 202 to the server 160. For example, the electronic device 100 may transmit the second image 202 to the server 160 using the communication circuitry 120.

For example, when operation 340 is omitted, the electronic device 100 may transmit the second image 202 obtained in operation 330 to the server 160.

For example, when operation 340 is performed, the second image 202 may be transmitted to the server 160 based on the information obtained by executing the third model 153. For example, the electronic device 100 may transmit the second image 202 to the server 160 when the similarity between the second image 202 and the actual image or the probability that the second image 202 is the actual image exceeds the threshold. Otherwise, the second image 202 may not be transmitted to the server 160. The second image 202 that is not transmitted may be used for training the first model 151, the second model 152, and/or the third model 153.

In operation 360, the electronic device 100 may transmit the detection result of the first image 201 to the server. For example, the electronic device 100 may transmit information about the detection result of one or more subjects of the first image 201 obtained using the first model 151 to the server 160 through the communication circuitry 120. The detection result may include, e.g., information about the position of the object included in the first image 201, the category of the object, and the probability that the object and the category match.

Optionally or additionally, the electronic device 100 may perform operation 370 after performing operation 310. In operation 370, the electronic device 100 may determine whether to transmit the detection result of the first image 201 to the server 160 by executing the fourth model 154. The electronic device 100 may perform operations 320 and 360 according to the determination result of operation 370. For example, when it is determined to transmit the detection result of the first image 201 to the server 160, the electronic device 100 may transmit the detection result of the first image 201 to the server 160 in operation 360. Further, when it is determined to transmit the detection result of the first image 201 to the server 160, the electronic device 100 may obtain the feature information related to the first image 201, which is the output of the intermediate layer of the first model 151, in operation 320.

FIG. 4 is a block diagram illustrating an example of an autonomous driving system of a vehicle according to an embodiment.

An autonomous driving system 400 of a vehicle according to FIG. 4 may be a deep learning network including sensors 403, an image pre-processor 405, a deep learning network 407, an artificial intelligence (AI) processor 409, a vehicle control module 411, a network interface 413, and a communication unit 415. In various embodiments, the elements may be connected through various interfaces. For example, sensor data sensed and output by the sensors 403 may be fed to the image pre-processor 405. The sensor data processed by the image pre-processor 405 may be fed to the deep learning network 407 running on the AI processor 409. The output of the deep learning network 407 run by the AI processor 409 may be fed to the vehicle control module 411. Intermediate results of the deep learning network 407 running on the AI processor 409 may be fed to the AI processor 409. In various embodiments, the network interface 413 communicates with an electronic device (e.g., the electronic device 100 of FIG. 1C) in the vehicle to transfer autonomous driving route information and/or autonomous driving control commands for autonomous driving of the vehicle to internal block components. In an embodiment, the network interface 413 may be used to transmit sensor data obtained through the sensor(s) 403 to an external server. In some embodiments, the autonomous driving control system 400 may include additional or fewer components as appropriate. For example, in some embodiments, the image pre-processor 405 may be an optional component. As another example, a post-processing component (not shown) may be included in the autonomous driving control system 400 to perform post-processing at the output of the deep learning network 407 before the output is provided to the vehicle control module 411.

In some embodiments, the sensors 403 may include one or more sensors. In various embodiments, the sensors 403 may be attached to different positions of the vehicle. The sensors 403 may be oriented in one or more different directions. For example, the sensors 403 may be attached to the front, side, rear, and/or roof of the vehicle to face in different directions such as forward-facing, rear-facing, and side-facing. In some embodiments, the sensors 403 may be image sensors such as high dynamic range cameras. In some embodiments, the sensors 403 include non-visual sensors. In some embodiments, the sensors 403 include radar, light detection and ranging (LiDAR), and/or ultrasonic sensors in addition to the image sensors. In some embodiments, the sensors 403 are not mounted to a vehicle having the vehicle control module 411. For example, the sensors 403 may be included as part of a deep learning system for capturing sensor data and attached to the environment or road and/or equipped to surrounding vehicles.

In some embodiments, the image pre-processor 405 may be used to pre-process sensor data of the sensors 403. For example, the image pre-processor 405 may be used to pre-process sensor data, split sensor data into one or more components, and/or post-process one or more components. In some embodiments, the image pre-processor 405 may be a graphics processing unit (GPU), a central processing unit (CPU), an image signal processor, or a specialized image processor. In various embodiments, the image pre-processor 405 may be a tone-mapper processor for processing high dynamic range data. In some embodiments, the image pre-processor 405 may be a component of the AI processor 409.

In some embodiments, the deep learning network 407 may be a deep learning network for implementing control commands for controlling an autonomous vehicle. For example, the deep learning network 407 may be an artificial neural network, such as a convolutional neural network (CNN), trained using sensor data, and the output of the deep learning network 407 is provided to the vehicle control module 411.

In some embodiments, the artificial intelligence (AI) processor 409 may be a hardware processor for running the deep learning network 407. In some embodiments, the AI processor 409 is a specialized AI processor for performing inference through a convolutional neural network (CNN) on sensor data. In some embodiments, the AI processor 409 may be optimized for bit depth of sensor data. In some embodiments, the AI processor 409 may be optimized for deep learning operations, such as operations of a neural network including convolution, dot product, vector and/or matrix operations. In some embodiments, the AI processor 409 may be implemented through a plurality of graphics processing devices (GPUs) capable of effectively performing parallel processing.

In various embodiments, the AI processor 409 may be coupled via an input/output interface to memory configured to provide an AI processor 409 having instructions to perform deep learning analysis on sensor data received from the sensor(s) 403 while the AI processor 409 is running and to determine a machine learning result used to operate the vehicle at least partially autonomously. In some embodiments, the vehicle control module 411 may be used to process instructions for vehicle control output from the artificial intelligence (AI) processor 409 and to translate the output of the AI processor 409 into instructions for controlling the modules of each vehicle to control various modules of the vehicle. In some embodiments, the vehicle control module 411 is used to control the vehicle for autonomous driving. In some embodiments, the vehicle control module 411 may adjust the steering and/or speed of the vehicle. For example, the vehicle control module 411 may be used to control the driving of the vehicle, such as deceleration, acceleration, steering, lane change, lane keeping, etc. In some embodiments, the vehicle control module 411 may generate control signals for controlling vehicle lighting, such as brake lights, turn signals, headlights, or the like. In some embodiments, the vehicle control module 411 may be used to control vehicle audio-related systems, such as the vehicle's sound system, the vehicle's audio warnings, the vehicle's microphone system, the vehicle's horn system, or the like.

In some embodiments, the vehicle control module 411 may be used to control notification systems that include warning systems for informing passengers and/or the driver of driving events such as approaching the intended destination or potential collisions. In some embodiments, the vehicle control module 411 may be used to adjust sensors such as the sensors 403 of the vehicle. For example, the vehicle control module 411 may modify the orientation direction of the sensors 403, change the output resolution and/or format type of the sensors 403, increase or decrease the capture rate, adjust the dynamic range, and adjust the focus of the camera. Further, the vehicle control module 411 may individually or collectively turn on/off the operations of the sensors.

In some embodiments, the vehicle control module 411 may be used to change the parameters of the image pre-processor 405 in such a way as modifying the frequency range of filters, adjusting features and/or edge detection parameters for object detection, or adjusting channels and bit depth. In various embodiments, the vehicle control module 411 may be used to control autonomous driving of the vehicle and/or a driver assistance function of the vehicle.

In some embodiments, the network interface 413 may serve as an internal interface between the communication unit 415 and the block components of the autonomous driving control system 400. Specifically, the network interface 413 may be a communication interface for receiving and/or transmitting data including voice data. In various embodiments, the network interface 413 may be connected to external servers to connect voice calls through the communication unit 415 or to receive and/or transmit text messages, transmit sensor data, update the software of the vehicle to the autonomous driving system, or update the software of the vehicle's autonomous driving system.

In various embodiments, the communication unit 415 may include various wireless interfaces of cellular or Wi-Fi methods. For example, the network interface 413 may be used to receive an update on operation parameters and/or instructions for the sensors 403, the image pre-processor 405, the deep learning network 407, the AI processor 409, and the vehicle control module 411 from an external server connected through the communication unit 415. For example, the machine learning model of the deep learning network 407 may be updated using the communication unit 415. According to another example, the communication unit 415 may be used to update the operation parameters of the image pre-processor 405, such as image processing parameters, and/or the firmware of the sensors 403.

In another embodiment, the communication unit 415 may be used to activate communication for emergency services and emergency contact in an accident or near-accident event. For example, in a collision event, the communication unit 415 may be used to call emergency services for assistance, and may be used to inform the outside of the collision details and emergency services of the vehicle's position. In various embodiments, the communication unit 415 may update or obtain the expected arrival time and/or destination position.

According to an embodiment, the autonomous driving system 400 shown in FIG. 4 may be configured as an electronic device 100 of a vehicle. According to an embodiment, if an autonomous driving release event occurs from the user during autonomous driving of the vehicle, the AI processor 409 of the autonomous driving system 400 may control to train autonomous driving software of the vehicle by controlling to input information related to the autonomous driving release event as training set data of the deep learning network.

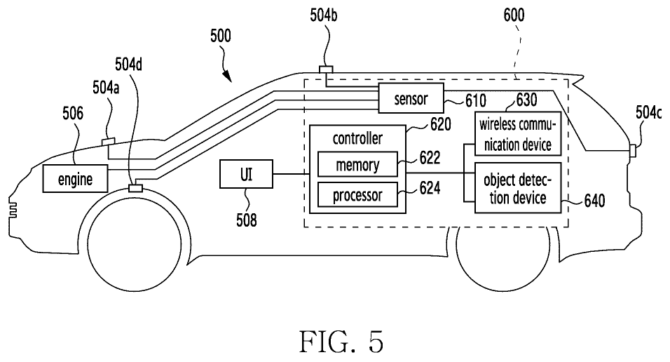

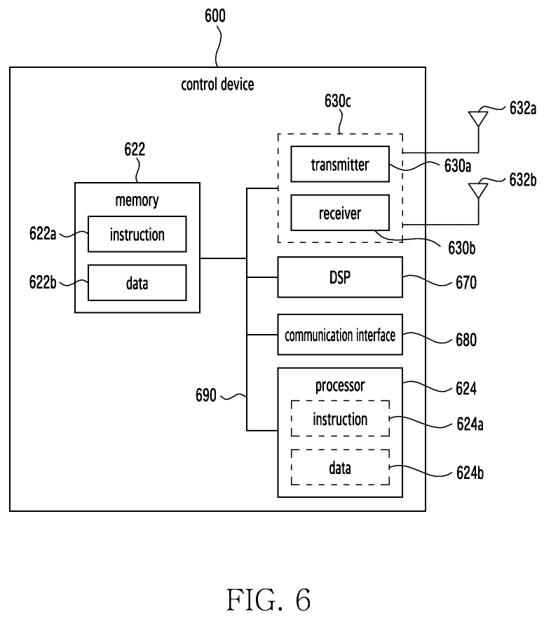

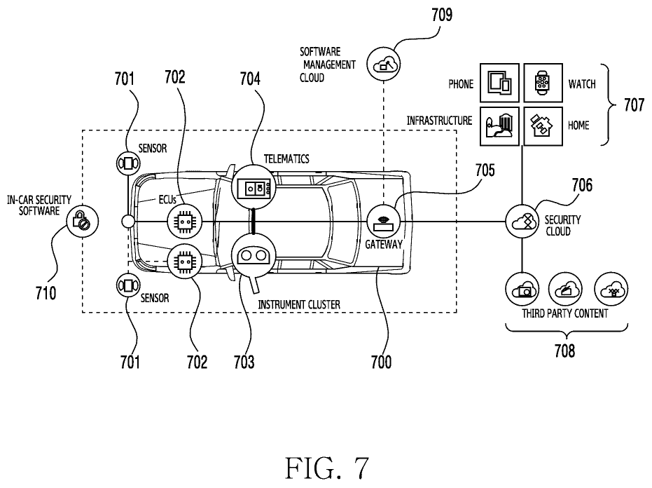

FIGS. 5 and 6 are block diagrams illustrating an example of an autonomous driving moving object according to an embodiment. FIG. 7 illustrates an example of a gateway related to a user device according to various embodiments.

Referring to FIG. 5, an autonomous driving moving object 500 according to the present embodiment may include a control device 600, sensing modules 504a, 504b, 504c, and 504d, an engine 506, and a user interface 508.

The autonomous driving moving object 500 may have an autonomous driving mode or a manual mode. For example, according to a user input received through the user interface 508, the manual mode may be switched to the autonomous driving mode, or the autonomous driving mode may be switched to the manual mode.

When the moving object 500 is driven in the autonomous driving mode, the autonomous driving moving object 500 may be driven under the control of the control device 600.

In the present embodiment, the control device 600 may include a controller 620 including memory 622 and a processor 624, a sensor 610, a communication device 630, and an object detection device 640.

Here, the object detection device 640 may perform all or some functions of the distance measurement device.

In other words, in the present embodiment, the object detection device 640 is a device for detecting an object positioned outside the moving object 500, and the object detection device 640 may detect an object positioned outside the moving object 500 and generate object information according to the detection result.

The object information may include information about the presence or absence of an object, position information about the object, distance information between the moving object and the object, and relative speed information between the moving object and the object.

The object may include various objects positioned outside the moving object 500 such as lanes, other vehicles, pedestrians, traffic signals, light, roads, structures, speed bumps, terrain, animals, or the like. Here, the traffic signal may be a concept including a traffic light, a traffic sign, and a pattern or text drawn on a road surface. Further, the light may be light generated by a lamp provided in another vehicle, light generated by a street lamp, or sunlight.

Further, the structure may be an object positioned around the road and fixed to the ground. For example, structures may include streetlights, street trees, buildings, power poles, traffic lights, and bridges. The terrain may include mountains, hills, or the like.

The object detection device 640 may include a camera module. The controller 620 may extract object information from an external image captured by the camera module and allow the controller 620 to process the information.

Further, the object detection device 640 may further include imaging devices for recognizing an external environment. In addition to LIDAR, RADAR, GPS devices, odometry, and other computer vision devices, ultrasonic sensors, and infrared sensors may be used, and these devices may be selected or operated simultaneously as needed to enable more precise detection.

Meanwhile, the distance measurement device according to an embodiment of the disclosure may calculate a distance between the autonomous driving moving object 500 and the object, and control the operation of the moving object based on the calculated distance in connection with the control device 600 of the autonomous driving moving object 500.

For example, when there is a possibility of collision according to the distance between the autonomous driving moving object 500 and the object, the autonomous driving moving object 500 may control the brake to reduce the speed or stop. As another example, when the object is a moving object, the autonomous driving moving object 500 may control the driving speed of the autonomous driving moving object 500 to maintain a predetermined distance or more from the object.

The distance measurement device according to an embodiment of the disclosure may be configured as a module in the control device 600 of the autonomous driving moving object 500. In other words, the memory 622 and the processor 624 of the control device 600 may implement the collision prevention method according to the disclosure in software.

Further, the sensor 610 may be connected to the sensing modules 504a, 504b, 504c, and 504d in the internal/external environment of the moving object to obtain various pieces of information. Here, the sensor 610 may include a posture sensor (e.g., a yaw sensor), a roll sensor, a pitch sensor, a collision sensor, a wheel sensor, a speed sensor, a tilt sensor, a weight detection sensor, a heading sensor, a gyro sensor, a position module, a moving object forward/reverse sensor, a battery sensor, a fuel sensor, a tire sensor, a steering sensor according to the rotation of the steering wheel, a moving object internal temperature sensor, a moving object internal humidity sensor, an ultrasonic sensor, an illumination sensor, an accelerator pedal position sensor, a brake pedal position sensor, or the like.

Accordingly, the sensor 610 may obtain sensing signals for moving object posture information, moving object collision information, moving object direction information, moving object position information (GPS information), moving object angle information, moving object speed information, moving object acceleration information, moving object slope information, moving object forward/rearward information, battery information, fuel information, tire information, moving object lamp information, moving object internal temperature information, moving object internal humidity information, steering wheel rotation angle, moving object external illumination, pressure applied to the accelerator pedal, pressure applied to the brake pedal, or the like.

Further, the sensor 610 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), or the like.

As such, the sensor 610 may generate moving object state information based on the sensing data.

The wireless communication device 630 is configured to implement wireless communication between the autonomous driving moving objects 500. For example, it allows the autonomous driving moving object 500 to communicate with the user's mobile phone or another wireless communication device 630, another moving object, a central device (traffic control device), a server, etc. The wireless communication device 630 may transmit and receive wireless signals according to an access wireless protocol. The wireless communication protocol may be Wi-Fi, Bluetooth, long-term evolution (LTE), code division multiple access (CDMA), wideband code division multiple access (WCDMA), and global systems for mobile communications (GSM), but the communication protocols are not limited thereto.

Further, in the present embodiment, the autonomous driving moving object 500 may implement communication between moving objects through the wireless communication device 630. In other words, the wireless communication device 630 may communicate with other moving objects on the road through vehicle-to-vehicle communication (V2V) communication. The autonomous driving moving object 500 may transmit and receive information such as a driving warning and traffic information through vehicle-to-vehicle communication, and may send or receive a request for information to/from another moving object. For example, the wireless communication device 630 may perform V2V communication by a short-range communication (dedicated short-range communication (DSRC)) device or a cellular-V2V (C-V2V) device. In addition to vehicle-to-vehicle communication, communication between the vehicle and another object (e.g., an electronic device carried by a pedestrian) (vehicle-to-everything (V2X) communication)) may also be implemented through the wireless communication device 630.

Further, the wireless communication device 630 may obtain information generated by infrastructures (traffic lights, CCTVs, RSUs, eNode Bs, etc.) positioned on the road or various mobilities including other autonomous driving/non-autonomous driving vehicles, as information for performing autonomous driving by the autonomous driving moving object 500 through a non-terrestrial network rather than a terrestrial network.

For example, the wireless communication device 630 may perform wireless communication with a low-earth orbit (LEO) satellite system, a medium-earth orbit (MEO) satellite system, a geostationary orbit (GEO) satellite system, or a high altitude platform (HAP) system constituting non-terrestrial networks through a non-terrestrial network-dedicated antenna mounted on the autonomous driving moving object 500.

For example, the wireless communication device 630 may perform wireless communication with various platforms constituting an NTN according to a radio access standard according to the fifth-generation new radio non-terrestrial network (5G NR NTN) standard, which is currently being discussed in the 3GPP.

In the present embodiment, the controller 620 may select a platform capable of properly performing NTN communication considering various pieces of information such as the position, current time, and available power of the autonomous driving moving object 500, and control the wireless communication device 630 to perform wireless communication with the selected platform.

In the present embodiment, the controller 620 is a unit that controls the overall operation of each unit in the moving object 500, and may be configured at the time of manufacture by the manufacturer of the moving object or may be additionally configured to perform an autonomous driving function after manufacturing. Alternatively, a configuration for performing consecutive additional functions may be included through an upgrade of the controller 620 configured at the time of manufacture. The controller 620 may be referred to as an electronic control unit (ECU).

The controller 620 may collect various data from the connected sensor 610, the object detection device 640, the communication device 630, and transfer control signals to the sensor 610, the engine 506, the user interface 508, the communication device 630, and the object detection device 640 included as other components in the moving object based on the collected data. Further, although not shown, control signals may also be transferred to the acceleration device, braking system, steering device, or navigation device related to the driving of the moving object.

In the present embodiment, the controller 620 may control the engine 506 and, for example, detect the speed limit of the road where the autonomous driving moving object 500 is driving and control the engine 506 so that the driving speed does not exceed the speed limit or control the engine 506 to accelerate the driving speed of the autonomous driving moving object 500 within a range in which the speed limit is not exceeded.

Further, if the autonomous driving moving object 500 is approaching or leaving the lane while the autonomous driving moving object 500 is driving, the controller 620 determines whether approaching and leaving the lane are based on a normal driving situation or other driving conditions, and controls the engine 506 to control the driving of the moving object according to the determination result. Specifically, the autonomous driving moving object 500 may detect the lanes formed on two opposite sides of the lane where the moving object is driving. In this case, the controller 620 may determine whether the autonomous driving moving object 500 is approaching or leaving the lane and, if determining that the autonomous driving moving object 500 is approaching or leaving the lane, determine whether such driving is due to an accurate driving circumstance or another driving circumstance. Here, an example of the normal driving circumstance may be a circumstance where the vehicle needs to change lanes. An example of the other driving circumstance may be a circumstance where the vehicle need not change lanes. If the controller 620 determines that the autonomous driving moving object 500 is approaching or leaving the lane in a circumstance where the lane change of the moving object is not required, the controller 1420 may control the driving of the autonomous driving moving object 500 so that the autonomous driving moving object 500 does not leave the lane but drives normally in its lane.

If there is another moving object or obstruction in front of the moving object, the engine 506 or the braking system may be controlled to decelerate the driving moving object and, in addition to speed, the trajectory, driving route, and steering angle may be controlled. Alternatively, the controller 620 may control the driving of the moving object by generating necessary control signals according to recognition information about other external environments such as driving lanes and driving signals of the moving object.

In addition to generating its own control signal, the controller 620 may control the driving of the moving object by performing communication with a peripheral moving object or a central server and transmitting a command for controlling peripheral devices through the received information.

Further, when the position of the camera module is changed or the angle of view is changed, it may be impossible to accurately recognize the moving object or lane according to the present embodiment. Thus, to prevent such issue, the controller 620 may generate a control signal to control to perform calibration on the camera module. Therefore, in the present embodiment, the controller 620 may generate a calibration control signal to the camera module to maintain the normal mounting position, direction, and angle of view of the camera module even when the mounting position of the camera module is changed by vibration or impact generated by the movement of the autonomous driving moving object 500. The controller 620 may generate a control signal to perform calibration on the camera module when the pre-stored initial mounting position, direction, and angle-of-view information about the camera module and the initial mounting position, direction, and angle-of-view information about the camera module measured during the driving of the autonomous driving moving object 500 are varied by a threshold or more.

In the present embodiment, the controller 620 may include memory 622 and a processor 624. The processor 624 may execute the software stored in the memory 622 according to a control signal from the controller 620. Specifically, the controller 620 stores data and instructions for performing the lane detection method according to the disclosure in the memory 622, and the instructions may be executed by the processor 624 to implement one or more methods disclosed herein.

In this case, the data and the instructions may be stored in a non-volatile recording medium executable by the processor 624. The memory 622 may store software and data through a suitable internal/external device. The memory 622 may be composed of a random access memory (RAM), a read only memory (ROM), a hard disk, and a memory device connected to a dongle.

The memory 622 may store, at least, an operating system (OS), user applications, and executable commands. The memory 622 may also store application data and array data structures.

The processor 624 may be a controller as a microprocessor or an appropriate electronic processor, a micro controller, or a state machine.

The processor 624 may be implemented as a combination of computing devices, and the computing device may be composed of a digital signal processor, a microprocessor, or an appropriate combination thereof.

Meanwhile, the autonomous driving moving object 500 may further include a user interface 508 for the user's input to the above-described control device 600. The user interface 508 may allow the user to enter information through appropriate interaction. For example, it may be implemented as a touch screen, a keypad, an operation button, or the like. The user interface 508 may transmit an input or command to the controller 620, and the controller 620 may perform a control operation of the moving object in response to the input or command.

Further, the user interface 508 may communicate with the autonomous driving moving object 500 through the wireless communication device 630 as a device outside the autonomous driving moving object 500. For example, the user interface 508 may enable interworking with a mobile phone, tablet, or other computer devices.

Further, although the autonomous driving moving object 500 includes the engine 506 in the present embodiment, other types of propulsion systems. For example, the moving object may be operated by electrical energy, and may be operated by hydrogen energy or a hybrid system in combination thereof. Therefore, the controller 620 may include a propulsion mechanism according to the propulsion system of the autonomous driving moving object 500, and may provide a control signal according thereto to the components of each propulsion mechanism.

Hereinafter, a detailed configuration of a control device 600 according to the present embodiment is described in more detail with reference to FIG. 6.

The control device 600 includes a processor 624. The processor 624 may be a general-purpose single or multi-chip microprocessor, a dedicated microprocessor, a microprocessor, a programmable gate array, or the like. The processor may be referred to as a central processing unit (CPU). Further, in the present embodiment, processor 624 may be used as a combination of multiple processors.

The control device 600 also includes memory 622. The memory 622 may be any electronic component capable of storing electronic information. The memory 622 may include a combination of the memories 622 as well as a single memory.

Data and instructions 622a for performing the distance measuring method of the distance measurement device according to the disclosure may be stored in the memory 622. When the processor 624 executes the instructions 622a, all or some of the instructions 622a and the data 622b required to execute the instructions 622a may be loaded on the processor 624 and used as instructions 624a and data 624b executed by the processor 624.

The control device 600 may include a transmitter 630a, a receiver 630b, or a transceiver 630c for allowing transmission and reception of signals. One or more antennas 632a and 632b may be electrically connected to the transmitter 630a, the receiver 630b, or each transceiver 630c, and may additionally include antennas.

The control device 600 may include a digital signal processor (DSP) 670. The DSP 670 may allow the moving object to quickly process the digital signal.

The control device 600 may include a communication interface 680. The communication interface 680 may include one or more ports and/or communication modules for connecting other devices to the control device 600. The communication interface 680 may enable the user and the control device 600 to interact with each other.

Various components of the control device 600 may be connected together by one or more buses 690, and the buses 690 may include a power bus, a control signal bus, a status signal bus, a data bus, or the like. Under the control of the processor 624, the components may transfer information therebetween through the bus 690 and perform a desired function.

Meanwhile, in various embodiments, the control device 600 may be related to a gateway for communication with a secure cloud. For example, referring to FIG. 7, the control device 600 may be related to the gateway 705 for providing information obtained from at least one of the components 701 to 704 of the vehicle 700 to the secure cloud 706. For example, the gateway 705 may be included in the control device 600. As another example, the gateway 705 may be configured as a separate device within the vehicle 700 that is distinguished from the control device 600. The gateway 705 communicatively connects a software management cloud 709, a secure cloud 706, and a network in the vehicle 700 secured by in-vehicle security software 710 having different networks.

For example, the component 701 may be a sensor. For example, the sensor may be used to obtain information about at least one of the state of the vehicle 700 or the state around the vehicle 700. For example, the component 701 may include a sensor 610.

For example, the component 702 may be an electronic control unit (ECU). For example, the ECUs may be used for engine control, transmission control, airbag control, tire pressure management.

For example, the component 703 may be an instrument cluster. For example, the instrument cluster may refer to a panel positioned in front of the driver's seat in the dashboard. For example, the instrument cluster may be configured to show the driver (or passenger) the information necessary for driving. For example, the instrument cluster may be used to display at least one of visual elements to indicate the engine's revolutions per minute or rotations per minute (RPM), visual elements to indicate the speed of the vehicle 700, visual elements to indicate the amount of remaining fuel, visual elements to indicate the state of the gear, or visual elements to indicate information obtained through the component 701.

For example, the component 704 may be a telematics device. For example, the telematics device may refer to a device that combines wireless communication technology and global positioning system (GPS) technology to provide various mobile communication services such as location information and safe driving within the vehicle 700. For example, the telematics device may be used to connect the driver, a cloud (e.g., the secure cloud 706), and/or the ambient environment and the vehicle 700. For example, the telematics device may be configured to support high bandwidth and low latency for 5G NR-standard technology (e.g., 5G NR V2X technology, 5G NR's non-terrestrial network (NTN) technology). For example, the telematics device may be configured to support autonomous driving of the vehicle 700.

For example, the gateway 705 may be used to connect the software management cloud 709 and the secure cloud 706, which are an in-vehicle (700) network and an out-of-vehicle network. For example, the software management cloud 709 may be used to update or manage at least one software required for driving and managing the vehicle 700. For example, the software management cloud 709 may be linked to in-vehicle (or in-car) security software 710 installed in the vehicle. For example, the in-vehicle security software 710 may be used to provide a security function within vehicle 700. For example, the in-vehicle security software 710 may encrypt data transmitted and received through an in-vehicle network using an encryption key obtained from an external authorized server for encryption of the in-vehicle network. In various embodiments, the encryption key used by the in-vehicle security software 710 may be generated corresponding to vehicle identification information (vehicle license plate, vehicle identification number (VIN)) or information uniquely assigned to each user (user identification information).

In various embodiments, the gateway 705 may transmit data encrypted by the in-vehicle security software 710 based on the encryption key to the software management cloud 709 and/or the secure cloud 706. The software management cloud 709 and/or the secure cloud 706 may identify the data received from which vehicle or from which user by decrypting the data encrypted by the encryption key of the in-vehicle security software 710 using a decryption key capable of decrypting the encrypted data. For example, since the decryption key is a unique key corresponding to the encryption key, the software management cloud 709 and/or the secure cloud 706 may identify the transmission entity (e.g., the vehicle or the user) of the data based on the data decrypted through the decryption key.

For example, the gateway 705 is configured to support the in-vehicle security software 710 and may be related to the control device 600. For example, the gateway 705 may be related to the control device 600 to support the connection between the client device 707 connected to the secure cloud 706 and the control device 600. As another example, the gateway 705 may be related to the control device 600 to support the connection between the third-party cloud 708 connected to the secure cloud 706 and the control device 600. However, the disclosure is not limited thereto.

In various embodiments, the gateway 705 may be used to connect the vehicle 700 with the software management cloud 709 for managing the operating software of the vehicle 700. For example, the software management cloud 709 may monitor whether the operating software of the vehicle 700 is updated and provide data for updating the operating software of the vehicle 700 through the gateway 705 based on monitoring that the operating software of the vehicle 700 is required to be updated. As another example, the software management cloud 709 may receive a user request for updating the operating software of the vehicle 700 from the vehicle 700 through the gateway 705, and provide data for updating the operating software of the vehicle 700 based on the reception. However, the disclosure is not limited thereto.

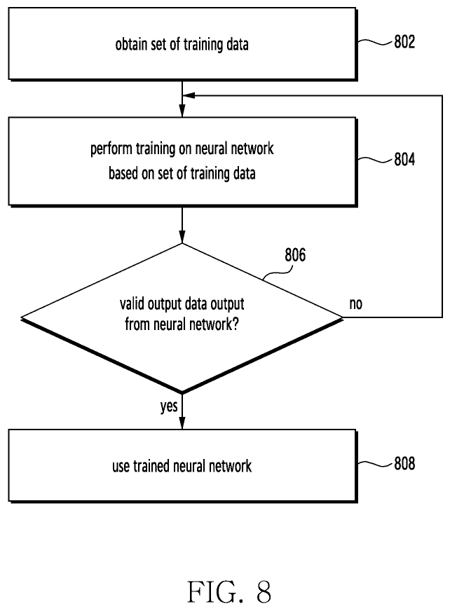

FIG. 8 is a view illustrating operations of an electronic device training a neural network based on a set of training data according to an embodiment.

The operations described with reference to FIG. 8 may be performed by the above-described electronic device (e.g., the electronic device 100 of FIG. 1C).

Referring to FIG. 8, in operation 802, the electronic device may obtain a set of training data according to an embodiment. The electronic device may obtain a set of training data for supervised learning. The training data may include a pair of input data and ground truth data corresponding to the input data. The ground truth data may indicate output data to be obtained from a neural network that has received input data, which forms the pair with the ground truth data. The ground truth data may be obtained by the above-described electronic device.

For example, when training the neural network for image recognition, the training data may include images and information about one or more subjects included in the images. The information may include the category or class of subjects identifiable through the image. The information may include the position, width, height, and/or size of the visual object corresponding to the subject in the image. The set of training data identified through operation 802 may include pairs of a plurality of training data. In the example of training the neural network for image recognition, the set of training data identified by the electronic device may include a plurality of images and ground truth data corresponding to each of the plurality of images.

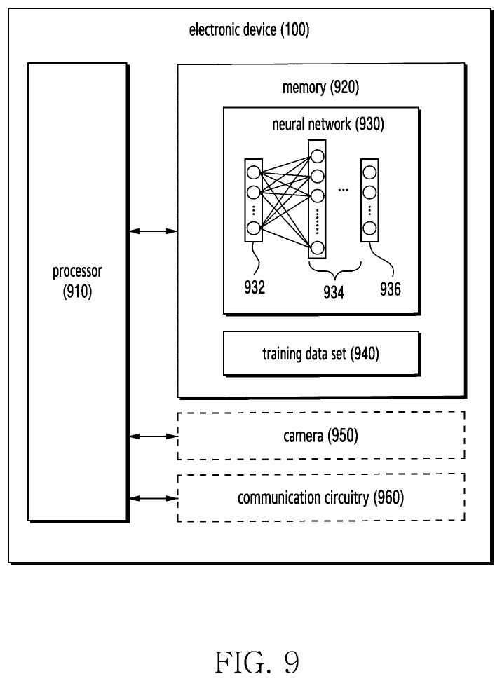

Referring to FIG. 8, in operation 804, the electronic device according to an embodiment may perform training on the neural network based on the set of training data. In an embodiment in which the neural network is trained based on supervised learning, the electronic device may input input data included in the training data to the input layer of the neural network. An example of the neural network including the input layer is described with reference to FIG. 9. From the output layer of the neural network receiving the input data through the input layer, the electronic device may obtain output data of the neural network corresponding to the input data.

In an embodiment, the training of operation 804 may be performed based on a difference between the output data and the ground truth data included in the training data and corresponding to the input data. For example, the electronic device may adjust one or more parameters (e.g., weights described below with reference to FIG. 9) related to the neural network to reduce the difference based on a gradient descent algorithm. The operation of the electronic device adjusting the one or more parameters may be referred to as tuning of the neural network. The electronic device may perform tuning of the neural network based on output data using a function defined to evaluate the performance of the neural network, such as a cost function. The difference between the above-described output data and the ground truth data may be included as an example of the cost function.

Referring to FIG. 8, in operation 806, according to an embodiment, the electronic device may identify whether valid output data is output from the neural network trained in operation 804. That the output data is valid may mean that the difference (or cost function) between the output data and the ground truth data meets a condition set for use of the neural network. For example, when the average and/or maximum value of the difference between the output data and the ground truth data is less than or equal to a designated threshold, the electronic device may determine that valid output data is output from the neural network.

When valid output data is not output from the neural network (No in 806), the electronic device may repeatedly perform training of the neural network based on operation 804. The embodiments are not limited thereto, and the electronic device may repeatedly perform operations 802 and 804.

In a state in which valid output data is obtained from the neural network (Yes in 806), based on operation 808, the electronic device according to an embodiment may use the trained neural network. For example, the electronic device may input other input data distinct from the input data input to the neural network as training data, to the neural network. The electronic device may use the output data obtained from the neural network receiving the other input data as a result of performing inference on the other input data based on the neural network.

FIG. 9 is a block diagram illustrating an electronic device according to an embodiment.

The electronic device 100 of FIG. 9 may include the above-described electronic device.

For example, the operations described with reference to FIG. 8 may be performed by the electronic device 100 of FIG. 9 and/or the processor 910 of FIG. 9.

Referring to FIG. 9, the processor 910 of the electronic device 100 may perform computations related to the neural network 930 stored in the memory 920. The processor 910 may include at least one of a center processing unit (CPU), a graphic processing unit (GPU), and a natural processing unit (NPU). The NPU may be implemented as a chip separated from the CPU, or integrated into a chip such as a CPU in the form of a system on chip (SoC). The NPU integrated into the CPU may be referred to as a neural core and/or an artificial intelligence (AI) accelerator.

Referring to FIG. 9, the processor 910 may identify the neural network 930 stored in the memory 920. The neural network 930 may include a combination of an input layer 932, one or more hidden layers 934 (or intermediate layers), and an output layer 936. The above-described layers (e.g., the input layer 932, the one or more hidden layers 934, and the output layer 936) may include a plurality of nodes. The number of hidden layers 934 may vary according to an embodiment, and a neural network 930 including the plurality of hidden layers 934 may be referred to as a deep neural network. The operation of training the deep neural network may be referred to as deep learning.

In an embodiment, when the neural network 930 has a structure of a feed forward neural network, the first node included in a specific layer may be connected to all of the second nodes included in other layers before the specific layer. Parameters stored for the neural network 930 in the memory 920 may include weights assigned to connections between the second nodes and the first node. In the neural network 930 having a structure of a feed forward neural network, the value of the first node may correspond to a weighted sum of values allocated to the second nodes, based on the weights assigned to connections connecting the second nodes and the first node.

In an embodiment, when the neural network 930 has a structure of a convolutional neural network, the first node included in a specific layer may correspond to a weighted sum of some of the second nodes included in other layers before the specific layer. Some of the second nodes corresponding to the first node may be identified by a filter corresponding to the specific layer. The parameters stored for the neural network 930 in the memory 920 may include weights indicating the filter. The filter may include, among the second nodes, one or more nodes to be used to calculate the weighted sum of the first node, and weights respectively corresponding to the one or more nodes.

According to an embodiment, the processor 910 of the electronic device 100 may perform training on the neural network 930 using the training data set 940 stored in the memory 920. Based on the training data set 940, the processor 910 may perform the operations described with reference to FIG. 8 to adjust one or more parameters stored in the memory 920 for the neural network 930.

According to an embodiment, the processor 910 of the electronic device 100 may perform object detection, object recognition, and/or object classification using the neural network 930 trained based on the training data set 940. The processor 910 may input the image (or video) obtained through the camera 950 into the input layer 932 of the neural network 930. Based on the input layer 932 to which the image is input, the processor 910 may sequentially obtain the values of nodes of layers included in the neural network 930 to obtain a set (e.g., output data) of values of nodes of the output layer 936. The output data may be used as a result of inferring information included in the image using the neural network 930. The embodiments are not limited thereto, and the processor 910 may input the image (or video) obtained from the external electronic device connected to the electronic device 100 through the communication circuitry 960 into the neural network 930.

In an embodiment, the neural network 930 trained to process the image may be used to identify the area corresponding to the subject in the image (object detection), and/or to identify the class of the subject represented in the image (object recognition and/or object classification). For example, the electronic device 100 may segment the area corresponding to the subject in the image based on a rectangular shape such as a bounding box using the neural network 930. For example, the electronic device 100 may identify at least one class matching the subject among a plurality of designated classes using the neural network 930.

In an embodiment, an electronic device in a vehicle may comprise communication circuitry, a camera, a memory storing instructions, and a processor. The instructions may, when executed by the processor, cause the electronic device to execute a first model to detect one or more subjects from a first image obtained from the camera and obtain, by executing a second model using feature information obtained from the first model, a second image based on the feature information.

In an embodiment, the instructions may, when executed by the processor, cause the electronic device to determine, by executing a third model using the second image, whether to transmit the second image to a server.

In an embodiment, the instructions may, when executed by the processor, cause the electronic device to transmit the second image to a server via the communication circuitry.

In an embodiment, the instructions may, when executed by the processor, cause the electronic device to obtain data related to subjects in the first image by executing the first model and transmit the data to a server via the communication circuitry.

In an embodiment, the first model may include a convolution neural network. The instructions may, when executed by the processor, cause the electronic device to obtain the feature information from a hidden layer of the convolution neural network.

In an embodiment, the hidden layer may include a convolutional layer.

In an embodiment, the first model and the second model may constitute a generative adversarial network (GAN).

According to an embodiment, a non-transitory computer-readable storage medium may store one or more programs. The one or more programs may, when executed by a processor of an electronic device of a vehicle including communication circuitry and a camera, cause the electronic device to execute a first model to detect one or more subjects from a first image obtained from the camera and obtain, by executing a second model using feature information obtained from the first model, a second image based on the feature information.

In an embodiment, the one or more programs may, when executed by the processor, cause the electronic device to determine, by executing a third model using the second image, whether to transmit the second image to a server.

In an embodiment, the one or more programs may, when executed by the processor, cause the electronic device to transmit the second image to a server via the communication circuitry.

In an embodiment, the one or more programs may, when executed by the processor, cause the electronic device to obtain data related to subjects in the first image by executing the first model and transmit the data to a server via the communication circuitry.

In an embodiment, the first model may include a convolution neural network. The one or more programs may, when executed by the processor, cause the electronic device to obtain the feature information from a hidden layer of the convolution neural network.

In an embodiment, the hidden layer may include a convolutional layer.

In an embodiment, the first model and the second model may constitute a generative adversarial network (GAN).

In an embodiment, a method of an electronic device of a vehicle including communication circuitry and a camera may comprise executing a first model to detect one or more subjects from a first image obtained from the camera and obtaining, by executing a second model using feature information obtained from the first model, a second image based on the feature information.

In an embodiment, the method may comprise determining, by executing a third model using the second image, whether to transmit the second image to a server.

In an embodiment, the method may comprise transmitting the second image to a server via the communication circuitry.

In an embodiment, the method may comprise obtaining data related to subjects in the first image by executing the first model and transmitting the data to a server via the communication circuitry.

In an embodiment, the first model may include a convolution neural network. The method may comprise obtaining the feature information from a hidden layer of the convolution neural network.

In an embodiment, the hidden layer may include a convolutional layer, and the first model and the second model may constitute a generative adversarial network (GAN).

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

Although specific embodiments of the disclosure have been described above, various changes may be made thereto without departing from the scope of the disclosure.

What is claimed is:

1. An electronic device in a vehicle, comprising:
communication circuitry;
a camera;
a memory storing instructions; and
a processor, and
wherein the instructions, when executed by the processor, cause the electronic device to:
execute a first model to detect one or more subjects from a first image obtained from the camera; and
obtain, by executing a second model using feature information obtained from the first model, a second image based on the feature information.

2. The electronic device of claim 1,
wherein the instructions, when executed by the processor, cause the electronic device to:
determine, by executing a third model using the second image, whether to transmit the second image to a server.

3. The electronic device of claim 1,
wherein the instructions, when executed by the processor, cause the electronic device to:
transmit the second image to a server via the communication circuitry.

4. The electronic device of claim 1,
wherein the instructions, when executed by the processor, cause the electronic device to:
obtain data related to subjects in the first image by executing the first model; and
transmit the data to a server via the communication circuitry.

5. The electronic device of claim 1,
wherein the first model includes a convolution neural network, and
wherein the instructions, when executed by the processor, cause the electronic device to:
obtain the feature information from a hidden layer of the convolution neural network.

6. The electronic device of claim 5,
wherein the hidden layer includes a convolutional layer.

7. The electronic device of claim 1,
wherein the first model and the second model constitute a generative adversarial network (GAN).

8. A non-transitory computer-readable storage medium storing one or more programs, wherein the one or more programs, when executed by a processor of an electronic device including communication circuitry and a camera, cause the electronic device to:
execute a first model to detect one or more subjects from a first image obtained from the camera; and
obtain, by executing a second model using feature information obtained from the first model, a second image based on the feature information.

9. The non-transitory computer-readable storage medium of claim 8,
wherein the one or more programs, when executed by the processor, cause the electronic device to:
determine, by executing a third model using the second image, whether to transmit the second image to a server.

10. The non-transitory computer-readable storage medium of claim 8,
wherein the one or more programs, when executed by the processor, cause the electronic device to:
transmit the second image to a server via the communication circuitry.

11. The non-transitory computer-readable storage medium of claim 8,
wherein the one or more programs, when executed by the processor, cause the electronic device to:
obtain data related to subjects in the first image by executing the first model; and
transmit the data to a server via the communication circuitry.

12. The non-transitory computer-readable storage medium of claim 8,
wherein the first model includes a convolution neural network, and
wherein the one or more programs, when executed by the processor, cause the electronic device to:
obtain the feature information from a hidden layer of the convolution neural network.

13. The non-transitory computer-readable storage medium of claim 12,
wherein the hidden layer includes a convolutional layer.

14. The non-transitory computer-readable storage medium of claim 8,
wherein the first model and the second model constitute a generative adversarial network (GAN).

15. A method of an electronic device including communication circuitry and a camera, the method comprising:
executing a first model to detect one or more subjects from a first image obtained from the camera; and
obtaining, by executing a second model using feature information obtained from the first model, a second image based on the feature information.

16. The method of claim 15, comprising:
determining, by executing a third model using the second image, whether to transmit the second image to a server.

17. The method of claim 15, comprising:
transmitting the second image to a server via the communication circuitry.

18. The method of claim 15, comprising:
obtaining data related to subjects in the first image by executing the first model; and
transmitting the data to a server via the communication circuitry.

19. The method of claim 15,
wherein the first model includes a convolution neural network, and
wherein the method comprises:
obtaining the feature information from a hidden layer of the convolution neural network.

20. The method of claim 19,
wherein the hidden layer includes a convolutional layer, and
wherein the first model and the second model constitute a generative adversarial network (GAN).
